(19) United States
(12) Patent Application Publication
(10) Pub. No.: US 2004/0153388 A1
(43) Pub. Date: Aug. 5, 2004

(54) Method and system for coupling investments for project funding

(76) Inventors: Daniel A. Fisher, McKinney, TX (US); David A. Kekich, Palos Verdes Estates, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/715,674

(22) Filed: Nov. 18, 2003

Related U.S. Application Data
(60) Provisional application No. 60/427,506, filed on Nov. 18, 2002.

(51) Int. Cl. G06F 17/60

(52) U.S. Cl. 705/36

(57) ABSTRACT

An investment funds management strategy and system utilizes low yield or no yield marginable assets to act as collateral to secure a credit facility. Loan proceeds are used to create a trading portfolio. Cash flow is generated from the portfolio by utilizing a DEALS fund management system. The DEALS system employs hedge funds, funds of funds, other funds, cash flow derivative strategies including; writing covered calls, writing, covered puts, spreads, exchange arbitrage, merger arbitrage, convertible arbitrage, currency arbitrage and other cash flow derivative tactics while stabilizing the underlying portfolio with hedging strategies such as long term puts and short term covered calls, costless collars and indexes.

### RELATED APPLICATIONS

This application claims priority of a prior filed provisional application having serial No. 60/427,506 and filing date Nov. 18, 2002 and entitled: Method And System For Implementing Monthly Or Other Periodic Cash Flow Project Funding Process.

### FIELD OF INVENTION

The present invention is a method and apparatus for implementing a Cash Flow oriented venture investment strategy.

### BACKGROUND OF THE INVENTION

Individuals, corporations, governments, and pension funds, venture funds, etc. make financial investments. A financial investment is basically a current commitment of dollars for a period of time in order to derive larger payments in the future. The objective of the investment is to derive future payments that will compensate for at least the time the funds are committed, the expected rate of inflation, and the risk today for future payments that are expected to be greater than the current investment.

A typical investment strategy involves identification of investment objectives, risk profile, inflation rates, and expected rates of return. This criterion forms the basis for selecting amongst the available investment opportunities. Most available investment opportunities fall within the general categories of financial assets or real assets. Most returns are relative to risk. Higher risk=higher return and vice versa.

Financial assets may be primarily broken down into several asset classes. One asset class is debt instruments, including fixed-income investments. For example, this asset class includes investments having a contractually mandated payment schedule, such as savings accounts, certificates of deposit (CD's), U.S. Treasury bills, U.S. Treasury Securities, U.S. Government agency securities, municipal bonds, and corporate bonds, including senior secured bonds, debentures, subordinated bonds, income bonds, and convertible bonds, collectively “debt obligations”. Preferred stock could fall within this class depending on the language of the issuance. Such investments typically offer relatively low risk, but offer little opportunity for capital gains and smaller cash flow returns. Additionally, many of such investment opportunities require minimum investments that are difficult to attain for many investors, e.g. $10,000 or more.

Another financial asset class is equity investments. This asset class includes common & preferred stock investments that represent company ownership; therefore these do not have contractually specified payments. Equities offer a broad range of risk/return opportunities varying as a function of the subject company fundamentals. Various strategies exist for selecting equities (stocks) offering greater or lesser risk. Equities of companies with high market capitalization and high credit ratings are typically considered relatively lower risk and generally have a greater promise of sustained long-term growth.

Additionally, other financial asset classes, known as derivatives, include special equity instruments such as warrants, options, equity baskets, futures contracts, etc, each of which is generally regarded as relatively higher-risk than standard debt and equity investments and can be used as a hedge against market gyrations.

Real Estate assets include real estate held directly, or indirectly through conduits such as REITS, etc. Various real estate investment opportunities are available, such as direct investment in raw land primarily for speculative/growth purposes (high risk) or in established income-producing properties primarily for cash flow (low risk), and income producing properties such as commercial & residential rental properties. Other investments in this genre may include ongoing business concerns, such as a restaurant franchise, manufacturing facilities, retail stores, etc.

Risk has an inverse curve to diversification. By allocating investment capital amongst several asset classes, lower risk may be the outcome, without affecting returns. Mutual funds are an excellent example because they offer investment opportunities in smaller dollar amounts through ownership of the fractional shares of the mutual fund. The underlying assets, which facilitate diversification by allowing investment in a broader range of assets for a given amount of investment capital. Accordingly, each investor has an opportunity to benefit, from an investment or group of investments that the investor might not otherwise be financial capable of making.

There are numerous mixed investments strategies available today, such as blended mutual funds, share bonds, etc. these mixed funds can be tailored to provide the investors with benefits such as mixed tax benefits, risk reduction, monthly income, etc.

Real Estate Investment Trusts (REITs) allow for an investment in real estate with the benefits of liquidity, diversity and professional management. REITs are a special corporation or trust specially designated by IRS for special treatment for the dividends paid to the investors. RIETs must hold a percentage of their portfolios in real estate investments. REITs offer mutual fund-like diversification benefits in the context of real estate assets.

This discussion makes it apparent that each investor must initially determine the capital they will invest, the frequency of those investments, the risk profile of those investments, the financial goals, etc, to create their investment plan or participation. Because an investor's investment capital may be limited, the allocation of funds to any one investment is done to the exclusion of those same funds to an alternative investment. the choices made can have a profound impact on the outcome of their investment goals.

For Example, an investor having $1,000,000 to invest may choose to invest $1,000,000 solely in high quality NYSE common stocks. Traditional wisdom indicates that such an investment is likely to provide a forecastable long-term growth with a defined risk profile.

Alternately the investor may choose to invest the $1,000,000 in a commercial office building with a well-established track record as consistent income-producing property. This investment provides a steady cash flow, with modest principle growth. Thus the investor gets the benefit, of relatively safe principle return, with a forecastable cash flow from rents.

Alternately, this same investor may choose to invest $400,000 in high quality common stock, and $600,000 in income-producing real estate. This will produce a higher principle return and a forecastable cash flow with a small increase in overall risk profile. Or, the investor could invest $1,000,000 in a mutual fund that invested approximately 40% in blue chip common stocks and 60% in income-producing real estate, if one existed, of course. Such strategies offer a degree of risk-reducing diversification.

Another alternative might be the investor obtaining a credit facility from a lending source, e.g. by pledging the real estate as collateral to support a loan for additional capital to purchase more common stock. However, this could be an issue when selling the real estate and could complicate the sale. Besides, most lenders frown on borrowing from real estate to purchase equities. Finding a lender may be next to impossible.

Domestic securities firms provide asset based lending. This lending allows an investor the ability to pledge a portfolio of securities, of a certain quality, to be pledged for a credit facility, which is greater than the 50% allowable under the margin lending rules. For example, the investment firm of J. P. Morgan Chase based offers such securities-based financing. For example, an individual having $2 million in liquid assets, e.g. marketable marginable securities, in an account pledged for the lending could purchase a luxury item, business assets, a restaurant franchise, or even a personal residence. The amount of the loan and ration of pledge will vary with each transaction.

An individual's investment options are limited because the investment capital of any given individual is limited. Certain desirable investments may require more investment capital that the individual has and therefore be unobtainable. Additionally, even with securities-based financing, most investors fail to achieve a diversification effect akin to those available to investors of mutual funds. More precisely, the single investor methodology lacks sufficient diversification and other beneficial effects compared to the pooling of many investors' assets (fractional share ownership), similar to those available through mutual fund purchases of securities.

The need for an investment methodology, which combines the elements of high quality principle growth, forecastable cash flow, and low risk profile for a complete investment return is unmistakable. This investment methodology should provide for the beneficial effects of diversification, pooled asset investment and fractional share ownership, without the need for the capital allocation processes.

### SUMMARY OF THE INVENTION

The present invention provides a method and apparatus for implementing an investment process which combines the use of securities lending to produce an above average principle growth with a forecastable cash flow. Financing is obtained by creating a pledge account to provide security for the lender. The assets must be of a certain quality according to the bank's standards for lending against those assets. The loan to value ratio depends upon many factors which vary from firm to firm. The lender secures the assets, called the “collateral pledge”, but not necessarily the income.

The project manager is defined as the facilitator of this process. The asset provider is the owner of the initial pledged assets and may be a corporation, institution, partnership, government agency, trust, not-for-profit organization, individual or a combination of any of the above.

The lending proceeds are used to create a specific type of cash flow portfolio designated for a predetermined purpose. This is an agreed arrangement between the asset provider and project manager.

The cash flows may be allocated to:

1. Debt service: the credit facility may be interest only with balloon, amortized, or a combination thereof.

2. Asset value lease payment: Most likely a dividend, could be treated as another more tax favorable distribution if necessary. For these purposes we will call it a dividend. The asset provider may receive 6%+/−annually of the credit balance outstanding with the lender. This payment could continue for the duration of the project as long as there is an amount outstanding with the lender.

3. Funding Strip: the amount designated to be paid monthly to project(s) funding for the duration of the funding period agreed upon by asset provider and/or project manager.

a. A portion of this fee will revert to TransVio Technology Ventures and/or nominee for New Venture oversight management and may be calculated as 20%+/−of the first month's net cash flow to new projects.

4. Portfolio Management Fee: to be paid to the cash flow portfolio (Capitalization Portfolio) management team. The annual fee will be approximately one percent of the funds under management and possibly a performance bonus fee to be set at the time the account is established.

5. Project Management Fee: annual 2%+/−fee of the Capitalization Portfolio paid monthly to TransVio Technology Ventures and/or nominee. 8% each month thereafter.

6. Set Up Fee: One percent of the cash under management, paid to TransVio Technology Ventures and/or nominee within 30 days+/−of the time the Capitalization Portfolio is set up.

7. DEALS License Fee: Annual 25 basis points or ¼ of one percent of the Capitalization Portfolio, paid annually in advance to Four Waves or nominee.

The asset provider(s) and project manager, the participants, will split the ownership of the project(s) according to the predetermined agreement prior to the initiation of this investment method. The participants get the benefit of each of the two investments. The first is the cash flow benefit, which pays the dividend (asset rental) and the management fee (method management) for the implementation of the method. The second benefit is the capital gain(s) on the funding portfolio plus the project receiving the funding strips.

By combining the two processes, cash flow and capital gain, the diversification lowers the overall risk profile associated with project funding. Variations of this method outlined in the drawings.

The greater the asset base to work from the more investment opportunities exist, with greater diversification opportunities. Asset providers are usually selected by matching their business model with a project which will add value to their current earning, or earning in the near future. In many cases, the project will provide a significant strategic advantage to their business models and make them more formability to their competitors. In some cases, it may even save the asset provider from obsolescence. One or more asset providers may be Limited Partners in an investment pool. This could be a venture capital partnership or another type of fund. In this case, the General Partner would be the project manager. The fund could be an open or closed fund and could fund single or multiple projects.

For real estate transactions, DEALS combines cash flow for debt service and operating expenses, while providing a dual capital gain opportunity in both the underlying real estate asset and the securities in the amortization portfolio.

The Capitalization Portfolio may be enhanced by borrowing funds from the real estate seller and investing them in the portfolio, with the expectation of earning a rate of return and a monthly cash flow in excess of the debt service on the note. Security for the note could be a second deed of trust on the property, all or part of the Capitalization Portfolio or both. In the event the lender for the first mortgage would have a lien on the Capitalization Portfolio, security for the note would reside in the property with an effective equity equal to the capitalization Portfolio (for a 100% first mortgage).

### DESCRIPTION OF THE DRAWINGS

FIG. 1 is a flow diagram of exemplary logic for implementing an investment process which combines the use of securities lending to produce an above average principle growth with a forecastable cash flow in accordance with the present invention.

FIG. 2 is a flow diagram of an exemplary embodiment of a method in accordance with the logic of FIG. 1.

FIG. 3 is a flow diagram of an exemplary embodiment of applying the steps of FIG. 2.

FIG. 4 is a flow diagram of an exemplary embodiment of the applying step of FIG. 3.

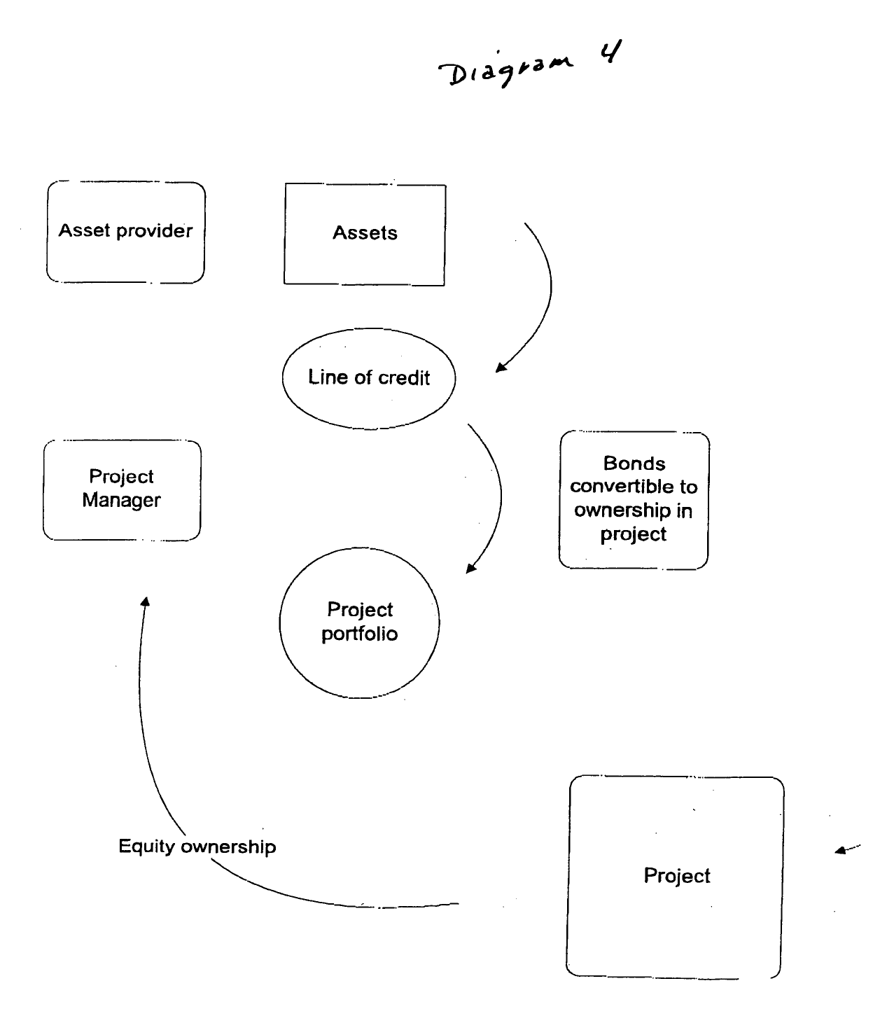

### DETAILED DESCRIPTION

### Hedged Cash Flow Portfolio Explanation

### “The Cash Flow Equity Collar”

1. We begin with a long equity position.

Equity is defined as: a publicly traded financial instrument representing ownership of debt, business, and/or business asset. The equity has an active trading volume on major domestic and international markets. The equity has an active options and/or futures market.

2. The portfolio hedges the principal erosion risk by purchasing puts (options with an inverse relationship to the value of the equity) on the underlying equities or sector put on underlying equity sector indexes or pools. The puts will have an expiration date of no less than 120 days from the purchase date of the equity.

The portfolio, after securing the put purchases, will now sell call (options with a direct relationship to the value of the equity) options. The call options will have an expiration date of no greater than sixty days. The goal for this hedging strategy is to get the collar as close to zero cost as possible.

The call options revenues meet the cost of the long put expense after the second call sale, and depending on market conditions this will vary.

The net cash flow income, net of principal increase or decrease is a spread between the cash flow generated by the call sales and the put purchase costs. The downside market risks are hedged by the long put positions.

What we have described is a potentially costless hedging strategy known as a “zero cost collar” or “costless collar”. The cost is as close to zero as possible.

An alternative, instead of, or in conjunction with the collar is to sell short the index(s), which the stock in the portfolio represents. For example 60% in Dow and 40% on NASDAQ, we would short the Dow & NASDAQ proportionally.

3. A covered call is an option contract backed by the shares of stock underlying the option.

Writing covered calls is a form of option writing in which (using calls as an example) the writer owns a quantity of the underlying security equivalent to the number of shares represented by the option contracts written.

If you own individual securities, you can always sell options against your stock positions to receive premiums giving your right to take the stock from you at a higher price. This concept with individual equities, called COVERED CALL WRITING, is used by numerous owners of individual securities.

4. This integral part of the patent applying for is selling covered calls combined with above hedging strategy creating a high yield cash flow portfolio with zero to minimal asset erosion.

5. Another integral part of the patent is using a Fund of Funds for the Capitalization Portfolio. The Fund of Funds individual fund managers would be managed by the Portfolio Manager who would be responsible for providing the necessary monthly cash flow from the Fund of Funds to provide funding for the project(s).

### New Company Development Process Terms Explained

Definitions: In order to understand this operational structure, it is important to understand the terms, and their meaning within the TransVio Technology Ventures program. These proprietary products listed below such as the DEALS program, the Periodic Capitalization System, and The Complete Entrepreneur Success Support Plan, have some or all of these terms. Full understanding of their functions will facilitate the understanding of the TransVio Technology Ventures product offering.

Annual Dividend: Paid quarterly, semi-annually, annually or other to DEALS participants, and Portfolio Lessors. Then amount is based on the amount of initial line of credit proceeds multiplied by 6%+/−. This dividend could remain constant regardless of Capitalization Portfolio fluctuations, conversions to equity, or changes in leased asset portfolio values. It may be a variable dividend, fluctuating with the Capitalization Portfolio's performance. Or, it may be a combination of fixed and variable, with a guaranteed minimum fixed dividend, increasing with positive Capitalization Portfolio performance. The dividend may also be waived. The dividend would be subject to agreement between DEALS participants and Portfolio Lessors.

Affiliate Venture Firm: An entity with a special structure designed to operate as an incubator or developer of new projects and or companies. These Affiliate Venture Firms could be started with four classes of stock; Preferred non-convertible, preferred convertible @ 5 to 1 common “A”, common “A”, and common “B”. An example of ownership structure could be; TransVio Technology Ventures owns the entire Preferred convertible “B” series, and 55% of the common “A”. 45% of the common “A” is offered to management, strategic partners, and key personnel. The preferred “A” is reserved for special unforeseen situations, and the common “B” is available for employees.

Affiliate management is chosen by their contacts in the community, the deals they have available for funding, and their experience as entrepreneurs. There must be an element of bootstrapping in their prior experience in order to share “war stories” with these new venture entrepreneurs to make them aware of the many challenges they will face. The majority of Venture Capital industry managers and employees have a high maintenance lifestyle broadcasting this message to the new venture management teams. This message directs the focus to the excesses of wealth, rather than the principles of building a sound business. The Affiliate Venture Firm Managers are recruited based on their own long term commitment to building a quality firm for themselves, therefore that is the message that the TransVio Technology Ventures program will send to new venture management teams.

The managers are responsible for developing relationships with public companies for Strategic Alliances, Treasury Stock, and Joint Venture Opportunities including new opportunities to the Affiliate Venture Firm, hiring & oversee the Success Accelerator Managers, and operating the day-to-day business. Affiliate Venture Firms are set up either geographically or by market specialization. Utilizing a Venture Specific Project Management System to ensure the best outcome a Success Accelerator Manager or managers are assigned to oversee the development of the New Venture.

Approved Business Plan: Once the decision had been made to move forward to capitalize the venture, the entrepreneur is given the conditions of the offer to capitalize. New business plans are reviewed and broken down by the market viability of the product and/or service, management team required, current market conditions, benefits to other TransVio Technology Ventures portfolio ventures under management, and future value expected at maturity. These plans are then reconstructed to maximize the use of the program features, and most efficient path to increase value for the shareholders.

The agreed upon structure includes the amount needed to capitalize the venture through maturity, the time needed for the project to reach maturity, and the responsibilities of both the entrepreneur and the TransVio Technology Ventures Affiliate Venture Firm. The Approved Business Plan is capitalized on a monthly schedule according to the capital needs of the New Venture. An important selection criterion is the success of the business plan absent of capital. Would the business still succeed in the event there was no capital? A good business must be able to work with or without venture capital, and only the timing issues support the need for capital.

The Approved Business Plan is then matched to a single Strategic Partner, or to a fund or a pool created by assets provided by one or more Strategic Partners, who will participate by providing capital, support, and market exposure for the new venture. The Affiliate Venture Firm and the Strategic Partner or fund form a specific use Joint Venture Entity or Entities specially designed for this program.

Capitalization Portfolio Fund: Approved Business plans are carefully examined to determine the amount of capital required for the new venture(s) to be considered self-sufficient. The Joint Venture Entity is the owner of the fund, and is responsible to ensure that the scheduled capitalization is provided to the new venture in a timely fashion. The new venture is capitalized on a monthly schedule according to the Approved Business Plan structure.

Our process maximizes the use of venture funds, customarily put directly into the new venture. The portfolio profits slow down the use of principal allocated to the new venture. In some cases, this gives the Joint Venture Entity additional capital in case more capital is required for the new venture. In the best cases, the venture is capitalized, and the Capitalization Portfolio is still whole, available for another new project. That opportunity is not available in today's venture capital financings.

After the capitalization amount has been determined, it is multiplied by approximately 135%, and that is the approximate size of the Capitalization Portfolio managed for the New Venture. For example, the New Venture requires $10M per year for three years therefore it has a $135M Capitalization Portfolio that will provide the monthly capital requirements. The Joint Venture Entity hires the Portfolio Manager to manage this portfolio and provide the capital according to the capitalization schedule. The Portfolio Managers actively work the fund for both capital gains, and monthly revenue. Capitalization Portfolios are private money funds not governed by retail rules that public mutual funds must adhere to.

The Capitalization Portfolio provides the New Venture Company with a monthly amount of capital according to the schedule. In many cases 5% or more of the total capitalization is provided up front to build the initial infrastructure, and the balance is paid in monthly “strips”. These strips usually grow larger to a peak toward the middle of the process and taper down to zero at the end of the process. Each New Venture is different. Therefore the process is flexible and includes Fungible Finance Factors in the case of unforeseen events.

Annual Dividend: To provide a return on capital during the capitalization process, the Joint Venture Entity offers the Strategic Partner providing the cash, assets and/or portfolio a 6%+/−preferred dividend. The strategic partner owns a preferred stock in the Joint Venture Entity that entitles it the dividend payment. The 6%+/−is calculated on the loan value of the cash and/or portfolio value provided for participation in New Venture. This is the first time in the history of venture capitalization where investors receive a return before the “exit” has been made.

Fungible Finance Factors: During the capitalization process, unforeseen events such as acquisition opportunities, expansion, property purchases, or market changes will dictate the need for an immediate need for additional capital, over and above the monthly amount. In these cases, the Capitalization Portfolio will provide a standby letter of credit to secure lines of credit, commercial mortgages, and arranging convertible debt financing. In other cases, Leases are obtained for equipment, intellectual property (software, licenses, etc.), and in some cases, labor. Deposits are initially secured by a letter of credit with each monthly payment going toward the deposit. The Capitalization Portfolio will make lease payments, debt payments, and monthly deposit payments during the period the letters of credit are on file. Afterwards, the New Venture will make the payments directly.

In cases where the convertible debt financing is quite large, $30M and up, the proceeds are placed in a portfolio to be managed by the fund manager. The new portfolio, owned by the New Venture, issues a standby letter of credit to secure a line of credit. The line of credit is used for whatever the purpose was for the convertible debt financing, and the portfolio is managed to make the payments on both debts. This relieves the New Venture from using operating capital to service the debt until the New Venture is Self-Sufficient. When the New Venture is Self-Sufficient, the debt will convert to equity, and the portfolio can be used to pay down, or pay off the line of credit.

This is an excellent way for a New Venture to build a credit history, get familiar with debt financing, and preserve valuable operating capital. In some cases, the public equity offering proceeds will be ample to pay off the debt, leaving the portfolio intact and available for further expansion.

Joint venture entity: The Strategic Partners and the Affiliate Venture Firm form a specific use entity. The entity is a “C” corporation with a preferred stock, a common “A”, and classes of common stock that track to the new venture (such as a class “C”). This joint venture entity hires the Affiliate Venture Firm to manage the new venture with their Success Accelerator Manager, and hires the Portfolio Manager for the Capitalization Portfolio.

The preferred stock entitles the asset provider an annual 6%+/−dividend paid quarterly, semi-annually, annually or other, calculated at initial dollar value of assets under management. The ownership of the common stock is structured as to allow the asset provider the opportunity to keep the debt activities of the entity from their balance sheet, while providing an addition to assets. The accounting provision details are a case-by-case scenario. The Asset Provider has the option of converting assets to equity in any New Venture, or simply participating in the New Venture for other purposes. Those purposes may be strategic such as revenue, market exposure, or technology collaboration. Conflicts of interest may be reasons that an equity conversion may not be feasible in a New Venture. This flexibility is a strong advantage of the Joint Venture Entity capitalization structure.

The New Ventures are identified by a tracking stock initially wholly owned by the joint venture entity. The Joint Venture Entity's equity portion of each New Venture is owned 50/50, or by another agreed upon ratio, by the shareholders of the Joint Venture Entity, and the tracking stock is paid out as a dividend after the new venture is taken public, and/or sold, or when the shareholders make the decision to take possession of the new venture(s) stock. In some cases, the Joint Venture Entity may retain ownership after the public offering, and reinvest the profits for additional New Ventures to be capitalized in the future.

The conversion elements are set at the inception of the Joint Venture Entity, and when each New Venture is chosen for capitalization. The Asset Provider has already agreed upon a conversion price for their equity portion of the New Venture and that amount may be deducted from the assets to be returned at the end of the capitalization period(s).

New Venture: Company or infrastructure project plan that has been approved for capitalization by TransVio Technology Ventures and/or an affiliate. New venture companies may eventually become Portfolio Lessors, and DEALS participants.

Periodic Capitalization System: Each New Venture is capitalized according to a schedule of cash flow needs. The monthly shortfalls calculated are based on growth projections & revenue tied closely to the up to three, five, or seven or more-year business development plan. Instead of providing capital in chunks or traunches, customary in venture capital, our process provides a monthly cash stream (known as Strips) that emulates revenue. The Success Accelerator Team may eliminate the need for milestones, or other restrictions which put undue pressure on the New Venture to “make things happen” in order to continue the capitalization process.

The capitalization amount is guaranteed, providing the New Venture Company with peace of mind. Unless the company files bankruptcy, engages in criminal acts, is sold, or is closed (restraining orders, government seizure, etc,) due to some extraordinary event, or any other conditions agreed upon by the Joint Venture Entity and New Venture, the capital will continue as agreed.

The New Venture, the Joint Venture Entity, and Portfolio Managers structure the schedule when the agreement to capitalize has been executed. The initial Strip may be 5% or more of the total agreed capitalization. The rest of the Strips grow toward a peak at the middle of the process tapering off toward the completion, although each case may be different. Considering unforeseen events are a natural coarse of business, Fungible Finance Factors are put in place to providing support for the overall capitalization. These Fungible Finance Factors are instigated with warrants payable according to the risks over and above the agreed capitalization amount.

Benefits include:

The elimination of the buffet effect (large expenditures due to available capital) of customary venture capital.

The New Venture entity trained to maximize use of cash flows, and strategically plan new expenditures that may coincide with new debt issues.

Better balance sheet utilization education for the management team that may result in a competitive edge later in the lifecycle of the company.

Elimination of the shotgun growth syndrome due to cash hoard available during customary venture capital methods at initial capitalization.

Strategic planning and growth projections based on revenues, systematic availability of capital, and debt service.

Eliminates the instant millionaire mentality for the New Venture principals, rather instilling a long-term payoff goal plan. This is critical in keeping the management motivated for a future payoff, not an instant one so prevalent in customary venture capital.

Quicker ramp up urgency to profitability for additional capital rather than a reliance on the cash pile still in the bank.

Elimination of rounds of funding preserves equity positions for all shareholders, and frees the management up to focus on the development of the business, not raising capital.

Monthly funding provides time for the Portfolio Managers to replenish the moneys put into the new venture.

Eliminates full exposure to risk capital instead putting monthly strips at risk. This balances the risk capital and increasing value of the New Venture.

The profits from the capitalization portfolio may, in some cases, exceed the amount of capital put into the New Ventures, making the principal risk zero.

In some cases the equity value of the New Venture will exceed the amount of the portfolio itself, eliminating principal risk.

In some cases, the amount of profit generated by participation in the new venture will exceed the total amount of capital put into the New Venture.

Early relationships with new companies that are destined to become dominate players in their market.

Elimination of the need, or justification to be the first, or only player in a given market. The success focus becomes more execution than isolation, just like it should be.

Portfolio Managers: The Capitalization Portfolio may be a Fund of Funds or another type of fund consisting of multiple managers. If so, there would be one Portfolio Manager, selecting an overseeing the individual fund managers. If not, the portfolio management team will provide all aspects of fund management for maximum cash return for projects with a conservative principal growth. The team consists of a nationally recognized fund management firm. TransVio Technology Ventures will assist in the research, return goals, and strategies. The Portfolio Managers are hired by the joint venture entity and paid a percentage of assets under management, possibly with a profit override if the fund returns exceed the contracted return goals.

Portfolio Lessor: The owner(s) of the portfolio collateral used to obtain the line of credit to initially fund the capitalization portfolio. The collateral account remains in the portfolio owner's name retaining full ownership, the ability to change the nature of the collateral remains intact, and the ability to continue to manage (if applicable) the portfolio continues as it had been prior. This collateral may be remanded to a stand by collateral status immediately after the capitalization portfolio has been structured by substituting the Capitalization Portfolio as primary collateral for the credit facility.

Success Accelerator Managers: The Joint Venture Entity hires the Affiliate Venture Firm to oversee and ensure the success of the new venture. The venture specific project management system is used and is headed by a Success Accelerator Manager with a support team. Not intended to interfere, or show lack of confidence in the new venture management, this team works offsite (at the Affiliate Venture Firm location) on developing strategic alliances, industry research and analysis, competitor offerings, personnel recruiting, and provide an interaction between the new venture and the joint venture entity board.

The Success Accelerator Managers are recruited based on their expertise in that industry, and in severe cases can serve as interim executive management. The compensation package may be a share of the warrants, or performance bonus equity in the new venture, and a competitive salary. The moneys budgeted for this team is included in the gross capitalization budget. 20% of the first Strip and 8% of each monthly Strip is currently allocated to this budget.

This Venture Specific Project Management System is crucial to the success of the new venture. It is very difficult to be aware of everything that could threaten the operation, or enhance it when day-to-day growth demands full attention from the new venture management team. It is a form of guardian angel insurance to add strength to the new venture.

Self-Sufficient: A new venture company is determined to be self-sufficient when sustainable profitability has been realized, the project is completed (real estate developments, factory, commercial construction, research, development, etc.), or the company is ready to be brought public for expansion capital to obtain sustainable profitability or for acquisitions that will accomplish the same goal.

Strategic Investors: Also known as Strategic Partners, Portfolio Investors, Joint Venture Partners, Asset Providers, And Treasury Stock Providers. Depending on the relationship, the name used to describe this participant will vary from deal structure to deal structure. These strategic partners may participate based on the benefits over and above the investment returns. These partners are usually public corporations, or large private companies that are interested in participating in new ventures with TransVio Technology Ventures' investment structure due to the nature of the new venture itself. The motivation is usually the new technology, new markets for their products, cross selling opportunities, new technology collaborations, acceleration of sales on slow moving products, and many other competitive advantages.

The strategic investor may receive the annual dividend paid by the Joint Venture Entity (see definition) for the use of the capital asset whether it is treasury stock, bond portfolio, security portfolio, affiliate securities, or just plain cash. The dividend is paid during the capitalization process based on the loan value of the value of the asset provided. This is a unique part of the DEALS program giving the investor money back while participating in the venture capital project, a first in the history of the industry.

Why would a corporation be interested in this program? Look at the following examples: A pharmaceutical company investing in a drug development company that will market the new drugs; An insurance company investing in a real estate franchiser, which sells their insurance products; A computer hardware manufacturer investing in a server farm company that will buy thousands of servers; A telecom company investing in an ISP that will resell their long distance, local phone, and dial up access products; Mutual fund management firm investing in a national chain of retail financial concierge services that will distribute their products and refer new investors; there are many, many examples of a strategic investment that achieves the objective.

The Strategic Investor could receive four forms of profit, an annual dividend, new revenue opportunities, market exposure from the new venture project, and capital gains when the new company is brought public. For the first time in the history of new opportunity investing, a financial product has brought value for the investor during the capitalization process. Traditionally, the returns are seen only if the new venture is sold or brought public. The risk exposure associated with customary new venture participation has been greatly reduced, and return on capital dramatically increased!

Complete Entrepreneur Success Support Plan: Entrepreneurs need more than just capital to succeed in today's competitive marketplace. The traditional model is nothing more than a form of packaging designed to get the new venture to the public markets fast to benefit the venture capitalists. The entrepreneur is not the client, much to their chagrin. Through our program, the investor is receiving monetary benefits during the capitalization process, removing the RUSH to get the new venture public or sold.

In The Complete Entrepreneur Success Support Plan the entrepreneur is the client maintaining the integrity of the development process and ensuring a stable viable new company that has a long-term objective. The strategic partners are ensured of a long-term relationship that can be beneficial for many years to come, and interest that exceeds the desire for just capital gain opportunities. The shooting star syndrome, present in current venture capital models, is eliminated. Over the long term, the public markets will place a premium on new companies that are developed in our system.

The Complete Entrepreneur Success Support Plan uses the following systems in this combination program to develop the strongest new venture companies to come into any given market. The goal is to bring these strong new companies public and acquire companies brought public prematurely by customary venture firms. There are hundreds of these fledging companies that are not fully developed and are trounced in the intense competitive markets of today.

The Periodic Capitalization System to build a financially savvy management team, reduce the risk capital exposure, and build a strong growth revenue planning mechanism. This system is based on a well-developed long-term growth plan that coincides with the monthly influx of capital to finance the growth ensuring a solid growth and eventual success.

Fungible Finance Factors support the monthly capitalization process and give the management team first hand experience with balance sheet utilization. This education will prepare the new company for unforeseen events and the use of creative financing methods.

The Ongoing Due Diligence Team (ODDT) act as guardian angels for management, develop strategic alliances, bring new opportunities from other TransVio Technology Ventures portfolio companies, and act as liaison between the new venture and joint venture entity. This team will continually assess the needs of the new venture and fulfill those needs before the need is critical. This eliminates the wide-eyed focus of management during the crucial growth phases that are overwhelming at times.

Strategic Partners give instant credibility to the new venture, provide mentoring, and provide instant market channels for products and services. In some cases, the Strategic Partners are customers buying product, vendors selling product, technology collaboration partners, and/or channel partners. A tremendous competitive edge.

Treasury Shares: Shares repurchased by a public corporation that have not been retired.

DEALS: An acronym meaning Dividends and Equity from Assets with Liquidity and Safety. This program provides the opportunity for a public company with repurchased shares or other assets to engage in New Venture for long-term growth without the use of operational cash. The specific design of the program provides a way to use these shares without affecting the balance sheet designation of the Treasury Shares, without adding liabilities, and adds positively to the balance sheet over throughout the course of the program. The Treasury Shares are leased, with little more than a mathematical risk to their re-issuance into the public float. The accounting is done on a company-by-company basis depending their method of accounting and customary disclosure issues.

The Treasury Shares are deposited in a company (the company loaning the treasury shares) account with our investment banking facilitator. The company agrees to leave the shares there for a predetermined period of time such as three, five or seven years. This agreement provides the investment bank with the flexibility to provide a credit facility. The line of credit is then used to build a Capitalization Portfolio for New Ventures. The investment bank then subordinates the Treasury Shares to a standby collateral status, using the new portfolio as the primary collateral.

The credit facility is serviced quarterly with no call provisions until the end of the term. The investment bank has more than twice the amount of collateral to secure the line of credit, the standby status, and time commitment give the bank the opportunity to use the treasury shares as a base for additional lending. Additionally, the Joint Venture Entity builds a credit history, balance sheet, and operating history supporting unsecured lending opportunities to release the Treasury Shares from their stand-by collateral status, effectively removing the risk.

The portfolios may fluctuate, but will not yield a call unless interest payments are skipped. In that event, only the portion of Treasury Shares representing the missed interest payment will be sold. This is highly unlikely yet it is mathematically possible. The portfolios are managed for principal stability, monthly revenues, and long-term principal growth. The Capitalization Portfolio purpose is to stretch the use of funds over several projects and risk scenarios, enabling further investments.

The Joint Venture Entity provides a buffer mechanism strategically structured to add value to the Treasury Share Lessors. The Joint Venture Entity pays a rental of the proceeds provided by the investment bank in the form of a preferred dividend. The losses passed from the New Ventures will, in most cases, offset taxable income to the Joint Venture Entity.

Using a specific use Joint Venture Entity, the share allocation and structure provides the treasury with a dividend to add to treasury cash for additional share repurchases, and creates investment capital for New Ventures that will add value to the company providing the use of Treasury Shares. The program targets specific types of ventures that will provide the participating companies with:

New revenue opportunities for current products and services.

New markets not previously accessible for current products and services.

New technologies to enhance the marketability of a companies products and services.

Equity participation in a new venture with capital gain opportunities.

Traditionally, a company must decide between short-term shareholder satisfaction and long-term growth initiatives. Sacrificing long-term objectives in favor of a share repurchase can negate the effects of a share repurchase leaving the shareholders increasingly frustrated with management.

This is the first and only opportunity for a public company to use a non-performing asset, such as Treasury Shares, to participate in venture capital opportunities that will add value for shareholders long term. The best of both worlds in one innovate new program.

Other entities such as institutions, trusts, partnerships, not-for-profits, government agencies, private companies or individuals may participate as well.

Venture Specific Project Success System: The allocation of resources and programs specifically for each new venture entity on behalf of the Joint Venture Entity. This system eliminates all the distractions from the planned goals of the shareholders. Each New Venture is handled specific to its needs addressing chronic under staffing and over-work facing new companies. The system addresses venture development for success assistance, capital requirements, strategic relationships, and entrepreneur centric goal achievement. This is the first system of its kind in existence today. The New Ventures the TransVio Technology Ventures system develops has a major competitive advantage entering the marketplace, and will become the dominant companies in their market segment.

Yield Recycle Program: Designed for owners of commercial paper, bank interest (CD's, etc), restricted stock portfolios, affiliate shares owned for long term, all types of bond portfolios, mortgage portfolios, cash assets and 144 structures to receive an additional yield on an existing portfolio with the opportunities to cherry pick their choice of New Venture opportunities. The portfolio is used initially as a primary collateral for a line of credit to be used to create a Capitalization Portfolio.

The Portfolio Lessor may receive a preferred dividend as a rental fee, and can execute a conversion right for equity participation in a pre-IPO new venture. The program operates like the DEALS program substituting Treasury shares for other types of portfolios.

This is the first and only program that can add value to a low yielding portfolio, or add investment yield for portfolio owners not wishing to dispose of their current portfolio, or provide flexibility for restricted share portfolios.

Therefore, this method is suitable for use with, for example, existing mutual funds, pension funds,/pension fund assets, insurance companies that manage assets for annuity products, new asset pools/portfolios likely to be formed in connections with new investment vehicles established specifically for the carrying out the inventive method. As used herein, an “investment vehicle” includes for example, a mutual fund, unit investment trust, a limited or general partnership, a limited liability company, a publicly held stock company, a C-Corp, S-Corp, Foreign Investment Trust, or any suitable form of structure.

Additionally, the present invention may be used to refinance real assets owned by an REIT using another asset as collateral for the refinancing. For example, an REIT could purchase or otherwise gain control of securities, thereby forming the first investment, and then reorganize its financing and/or structure, thereby acquiring the second investment. Alternatively, the REIT could pool its current outstanding shares or shareholders and use those shares as the first investment.

It is particularly advantageous to use as a first investment a portfolio of securities selected to achieve an objective of growth, e.g. long term growth, and as a second investment any income-producing asset. As used herein, an investment selected for achieving an objective of “growth” is any asset of a type generally selected for its ability, inclination or intent to produce growth of capital. This may include portfolios including individual investments having other income than growth characteristics. As used herein, an “income producing” asset, or an asset “selected to achieve an income-producing” asset is any asset of a type generally selected for its ability or inclination or intent to produce income. This combination provides both growth and income opportunities as well as sufficiently stable collateral to support collateral-backed lending and a high degree of leverage. Additionally, these complementary investments may be managed to provide synergistic effect. In particular, they may be managed with a common objective of enhanced returns to the investor by cross-utilizing the growth of the securities and the income from the real estate to provide enhanced returns. The synergy is particularly acute because of the liquidity of the securities investments and the illiquidity of the real estate investments.

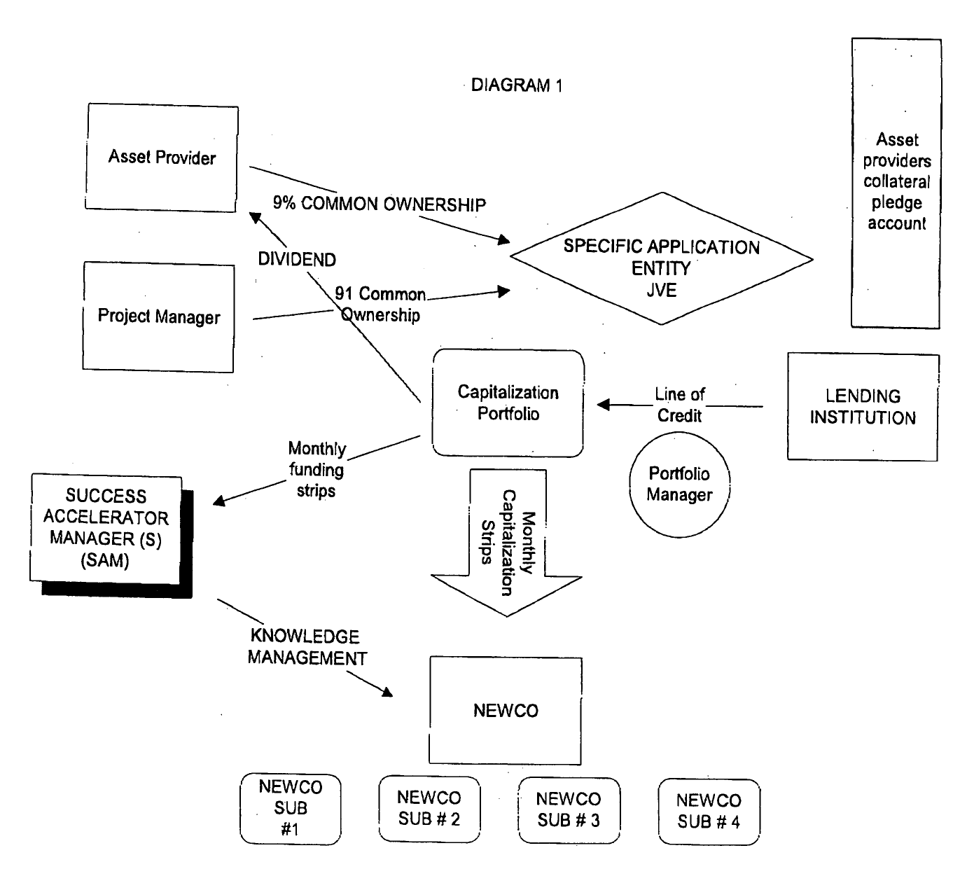

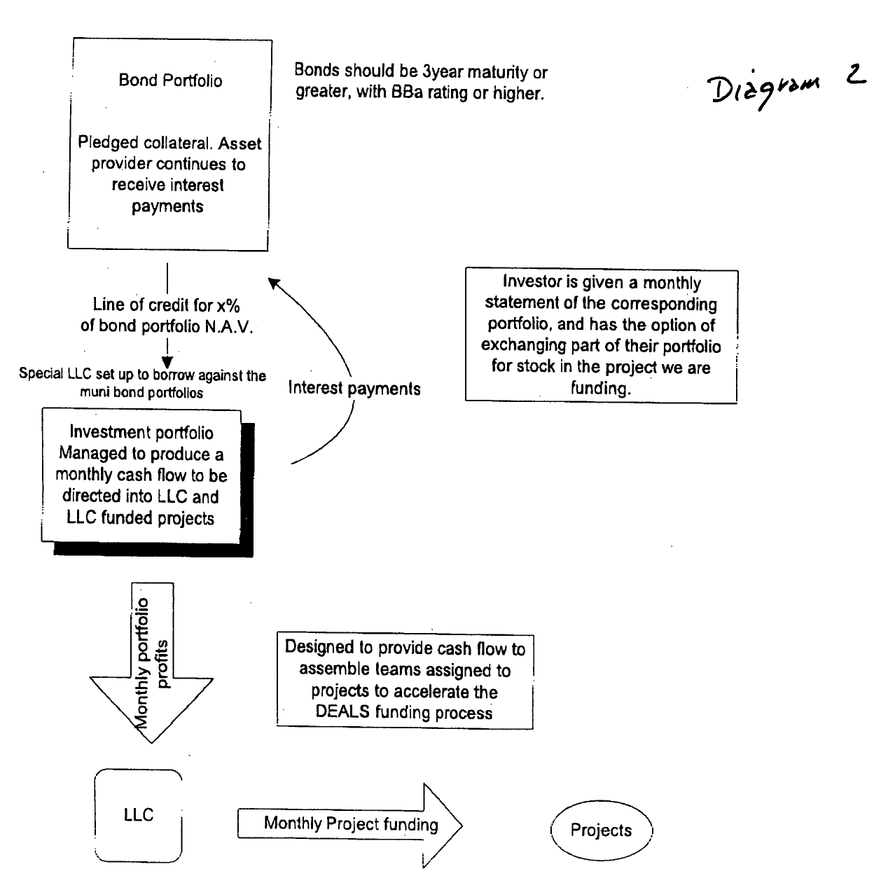

FIG. 2 is a flow diagram of an exemplary embodiment of a method in accordance with the logic of FIG. 1, which involves investment in growth securities and income producing real estate. The example of FIG. 2 involves establishment of a new investment vehicle, namely an investment fund, by an entity referred to as a Program Manager.

Referring now to FIG. 2., the exemplary method starts with the receipt of capital contributions from investors. For example, the capital contributions may be received in cash and deposited with an investment firm for cash management and creation of managed securities portfolio as discussed below.

The capital contributions are aggregated, e.g. pooled, and at least a portion of them is used to establish a first investment. In this example, the first investment is a portfolio of securities purchased with the aggregated capital contributions. It will be appreciated that in other embodiments, a fund is similarly “established” although at least some of the shares in the portfolio may have been purchased before receipts of an investor's capital contributions and that the investor is therefore simply “buying in” to an established portfolio. As used herein, the term “securities” is intended to be broader than its typical industry usage, and in particular to include at least any equities, bonds, debentures other debt obligations, mutual funds, mortgages, cash, or combinations thereof.

In this example, the portfolio comprises primarily equities, e.g. common stock of “blue chip” companies, or other high-quality investments selected such that the portfolio is intended to achieve an objective of long-term growth. Such a portfolio is advantageous because of the historic stability of equities and the proven capacity for sustained long-term growth. Various techniques are well known in the art for selecting equities and/or a portfolio for achieving an objective of long-term growth. In this example, the fund holds the portfolio of securities and any residual cash from capital contributions, income etc. such that a proportionate share of the portfolio and any residual cash or income is owned by each of the independent investors. This may involve issuance of shares or a statement of shares owned as is well known in the mutual fund industry. Additional equities may be periodically added or removed from the portfolio in the course of administering the fund, as is well known in the art.

In accordance with the present invention, the portfolio is then actively managed with the objective of providing enhanced returns. For example, the enhanced returns may be the result of stock selection, growth, diversifications, re-balancing, of the portfolio, etc. Optionally, dividends, income, etc resulting from ownership of the securities may be distributed to the investors, held for reinvestment, reinvested, etc. Various such actions may increase the securities available as collateral or reduce the degree of leverage of the portfolio. Numerous techniques are known in the art for actively managing a securities portfolio with the objective of providing enhanced returns.

In accordance with the present invention, the portfolio is then collateralized, e.g. pledged as collateral, to obtain financing. in the example FIG. 2, the financing includes a line of credit. In a preferred embodiment, the financing is provided by an investment firm, namely the investment firm actively managing the portfolio. In this manner, it is anticipated that favorable financing will be obtainable as a consequence of the financing being collateralized by a portfolio under the investment firm's management and control.

Preferably, the financing obtained provides leverage of the first investment in the range of 50-100%, and more preferably in the range of 50-80%, such ranges may be more or less, but in any event should conform to traditional collateral-backed lending practices and offering substantial opportunities for enhanced returns while assisting to ensure that any decreases in value of the equities portfolio do not affect prescribed loan collateralization by a portfolio under the investment firm's management and control.

The financing, e.g. line of credit is then used to acquire a second investment. In the example of FIG. 2, the second investment is an investment selected to achieve an income-producing objective, namely, a revenue producing securities account.

In certain embodiments, the acquisition of a second investment, and/or the obtaining of financing, is delayed until the first investment, or a fund holding the first investment reaches a predetermined threshold, e.g. $100 Million of capitalization or a predetermined percentage of the total value of the collateralizable first investment. For example, this may be determined by operation of a data processing system in accordance with the present invention, as discussed below.

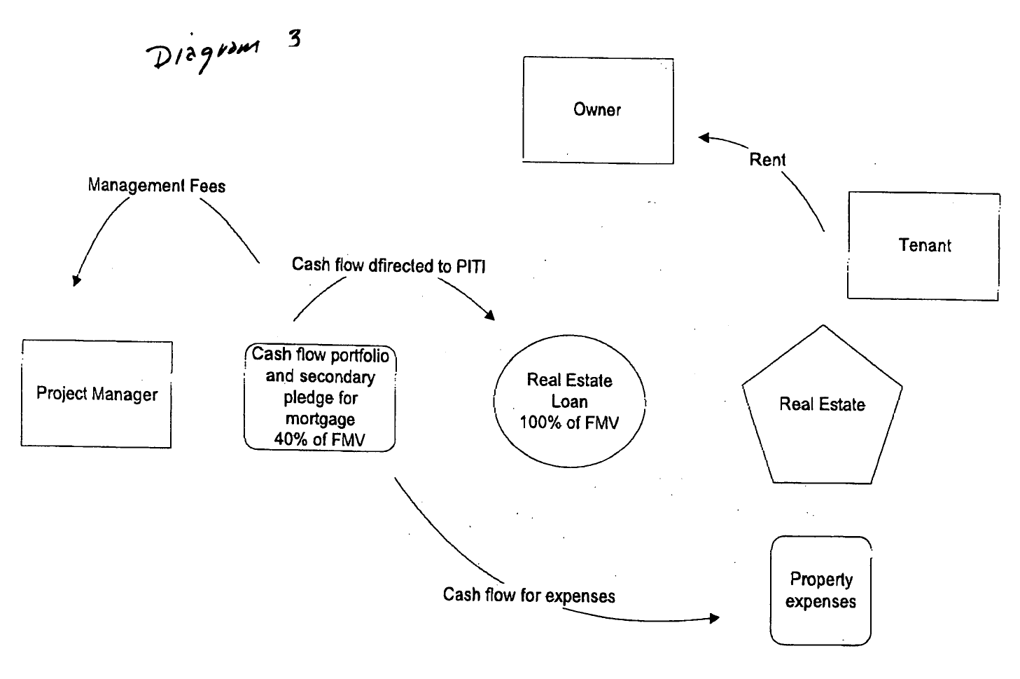

Additionally, the example of FIG. 2 ends with applying at least a portion of any returns, namely the income, on the second investment, to the benefit of the independent investors. This step is discussed further below with reference to FIG. 3. In this manner, each of the plurality of independent investors effectively becomes an investor in a combined investment of the first and second investments. Legal title to the second investment will be held by the Joint Venture Entity. In some embodiments each of the independent investors becomes an owner of a proportionate shares of the second investment by ownership of a fund holding the second investment. In other embodiments, ownership shares are issued to each of the investors to reflect all ownership, interest in the combined investment.

Specifically, the flow diagram of FIG. 3 provides exemplary logic of income from income-producing assets acquired with enhancing collateralized by a securities portfolio may be applied to the benefit of the investors in the securities portfolio. referring now to FIG. 3, the exemplary applying step starts with payment of management expenses associated with the income-producing assets, as shown at steps 41 and 42.

It is next determined whether there is any income remaining from the Capitalization Portfolio. If there is remaining income, it is determined whether a distribution is desired. If so, at least a portion of the income is distributed to the investors, and it is again determined whether there is any remaining income.

If it is determined that a distribution. is not desired, it is then determined whether greater leverage is desired, as shown. If so, at least a portion of the income is used to purchase additional assets, e.g. additional new venture investments. For example, the income may be pooled with additional, previously received income, as discussed below. To the extent that the financing collateralized by the portfolio is used to make the purchase of additional assets, this further leverages the portfolio. It is then again determined whether there is any remaining income.

If it is determined that greater leverage is not desired, then at least a portion of the income may be used to decrease leverage. For example, a portion of the income may be used to purchase additional securities for the portfolio, to add cash to the portfolio and/or related investment vehicle, or to reduce a debt obligation on the income-producing assets resulting from the financing therefore, e.g. by paying down the line of credit used to purchase the Capitalization Portfolio. Alternatively, at least a portion of the income may be applied to pay operating expenses relating to the first or second investment, including any management fees for operating the investment vehicle. It is then again determined whether there is any remaining income as shown.

In this example, this process continues until all income for a given period has been applied to the benefit of the investors in the investment vehicle holding the portfolio of securities.

Any increase in value of the first investment, e.g. the securities portfolio, may be reinvested to provide a source of additional collateral to either reduce the extent which the portfolio is collateralized/leveraged, to realize additional gains/profits, or to increase the amount of capital available as collateral.

It should be noted that the first and second investments may be managed with a common goal of providing enhanced returns to each or both asset classes and to provide a synergistic effect by cross-utilizing each asset's unique characteristics. For example, the growth of the securities and the income from the Capitalization Portfolio may be cross-utilized to provide enhanced returns. In this manner, an extremely versatile investment management platform is provided that will enhance the overall safety of the combined asset investment while providing enhanced reform. This synergy is particularly acute because of the liquidity of the securities investments and the illiquidity of the New Ventures. For example, in times of low interest rates, any debt on both investments may be adjusted accordingly by locking in long term debt on the income-producing investment. This will allow for an opportunity to purchase additional investments. Alternatively, any income from the second investment may be used to reduce the debt collateralized by the first investment, thereby enhancing composite returns to the investor. In times favorable to growth of securities, any income from the second investment may be used to acquire additional growth, of securities from the first investment, thereby enhancing composite returns to the investor. Accordingly, such a combined asset class investment may be managed, and the returns from each investment cross-utilized, to cause the income-producing asset to service the debt used to acquire it, the eventual result being free and clear ownership of both the securities portfolio and the equity in the New Venture. In this manner, each investor effectively acquired two investments for the price of one.

As referred to above, the present invention is equally applicable to an already established investment vehicle, e.g. one in which the capital contributions of the independent investors have already been received and/or a first investment is already held by the investment vehicle. A first investment of such an existing investment vehicle may be collateralized to obtain financing, the financing being used to acquire a second investment, at least a portion of any returns on the second investment being applied to the benefit of the investors. Accordingly, for example, Investment Group ABC may pledge as collateral all or a portion of the underlying assets of its XYZ Fund, proportionate shares of which are already held by multiple independent investors. Financing obtained by collateralization of such assets may then be used to purchase a second investment, e.g. Capitalization Portfolio, and the income or other return on the portfolio may be applied to the benefit of the investors. In this manner, existing investors of the XYZ Fund get additional investment utility for each dollar of investment capital by becoming the beneficiaries of the additional real estate or other investments without a need for additional capital contributions.

In certain embodiments of the invention, investors shall receive regularly scheduled distributions equal to their proportionate share.

Having thus described particular embodiments of the invention, various alterations, modifications, and improvements will readily occur to those skilled in the art. Such alterations, modifications and improvements are made obvious by this disclosure are intended to be part of this description though not expressly stated herein, and are intended to be within The spirit and scope of the invention, Accordingly the foregoing description is by way of example only, and act limiting. The invention is limited only as defined in the following claims and equivalents thereto,

What is claimed is:

1. A method for implementing a combined investment comprising the steps of: providing an asset provider, a project manager, a specific application entity, a capitalization portfolio, a success accelerator manager, a new company, a portfolio manager, a lending institution and an asset provider collateral pledge account; implementing a combined investment strategy through borrowing funds back by marginable assets.
